(19) United States
(12) Patent Application Publication
(10) Pub. No.: US 2025/0208932 A1
(43) Pub. Date: Jun. 26, 2025

(54) SYSTEMS AND METHODS FOR PREDICTING EVENTS AND DETECTING MISSED EVENTS

(71) Applicant: The Bank of New York Mellon, New York, NY (US)

(72) Inventors: Innamul Hassan Abdul Azeez, Chennai (IN); Sridhar M. Seetharaman, New York, NY (US); Siva Sailam Thekkedathumadathil Rajamany, Chennai (IN)

(21) Appl. No.: 18/432,668

(22) Filed: Feb. 5, 2024

(30) Foreign Application Priority Data
Dec. 20, 2023 (IN) 202321087432

(51) Int. Cl. G06F 9/54

(52) U.S. Cl. CPC G06F 9/542

(57) ABSTRACT

Systems and methods for predicting events and detecting missed events receive an event identifier and historical data for and event; calculate an event frequency of the event; identify a first model of a plurality of models, in which the first model is identified based on the calculated event frequency of the event, and in which different models are associated with different event frequency designations; train the first model based on the historical data for the event, in which training the first model based on the historical data for the at least one event further includes: identifying at least one event change point in the historical data; and calculating an event time slot based on the at least one event change point in the historical data; and generate a prediction of one or more predicted future events based at least in part on the first model.

### CROSS-REFERENCE TO RELATED APPLICATIONS

This application claims priority to India patent application No. 202321087432, filed Dec. 20, 2023, the subject matter of which is incorporated herein by reference in entirety.

### BACKGROUND

Service providers may provide a spectrum of services to their clients. These services may encompass a diverse range, from technical functionalities to specific operational processes tailored to meet the specific needs of clients, both internal and external. One or more services may be associated with a series of distinct events may be required, each characterized by their repeatability and unique identifiers. For instance, in a service providing file uploads over File Transfer Protocol (FTP); an event within this service may occur when a client initiates the transmission of a file to the service provider's server. This may encompass various stages, including file validation, transfer initiation, completion, and error handling. By way of another example, for an Application Programming Interface (API) service, an event may transpire when a client triggers a specific request, such as engaging with the provided API. This action may encompass endpoint access, data transmission, authentication, processing, and response management, etc. Moreover, various batch jobs, executed on predefined schedules or triggered by specific conditions, illustrate another set of possible events. These automated tasks may encompass diverse functionalities such as data processing, database updates, and report generation, etc. Included in these services may be robust monitoring, logging, and tracking mechanisms implemented by service providers. These mechanisms may enable the tracking of event frequency, success rates, errors, and performance metrics, fostering an environment conducive to seamless integration and optimized operation within the clients' business processes. However, verifying that these events actually take place as scheduled may be challenging.

The predictability and regularity of events within service consumption may form the backbone of operations for both clients and service providers. When these repeatable patterns are disrupted, such as when an expected event fails to occur, it often serves as an early indicator of potential issues within the service framework.

For example, a client may routinely send a trade file via FTP every day at 8:00 AM. If, for any reason, this expected event is missed or delayed, it could signify various underlying problems at different layers of the service infrastructure:

Client-Side Issues: The problem might originate from the client's end, and/or may be due to technical glitches, system failures, or misconfigurations within the client's infrastructure that hinder their ability to initiate and send the trade file as scheduled.

Service Provider Problems: The issue may lie within the service provider's system, and/or may be caused by server downtimes, network interruptions, software bugs, or unexpected system changes that obstruct the reception or processing of the trade file at the specified time.

Intermediary Connection Complications: The breakdown may occur at an intermediary connection layer between the client and the service provider. Issues like network outages, routing problems, or communication errors between systems may disrupt the successful transfer of the trade file.

Predicting and detecting missed events within patterns of service consumption can be important for both clients and service providers, signaling potential issues within the service framework. However, accurately predicting these event patterns becomes challenging when there is inadequate or unreliable information available. The absence of clear historical data or established patterns makes identifying irregularities difficult. This lack of insight into anticipated events complicates the identification of disruptions or anomalies, leaving both clients and service providers vulnerable to operational uncertainties. The multifaceted nature of these challenges, stemming from potential issues at various layers like client-side problems, service provider disruptions, or intermediary connection complications, exacerbates the complexity of diagnosing missed events. Insufficient information about event patterns impedes the ability to swiftly detect deviations, leaving stakeholders in a state of uncertainty regarding the stability and reliability of the service provided.

By monitoring repeatable events, abnormalities in event patterns may be detected (e.g., an event has been missed), and notification may be proactively sent to impacted parties before such abnormalities impact business and/or technical processes. The problem is that often systems do not have enough reliable information about event patterns. This can be a result of several factors including: (1) event information shared by the client is not accurate; (2) event information has changed over time and becomes outdated; (3) event information is not shared with the monitoring entity; etc. As a result, the schedule or pattern of the clients' events is often not known, and monitoring of such events becomes an untrivial task. Due to these and other factors, current attempts to monitor for missed events are often obscured by generation of numerous false positives. This may make the data unreliable and render the monitoring useless.

What is needed, therefore, is systems and method which may enable reliably predicting events and detecting when anticipated events do not occur, e.g., detecting missed events.

### SUMMARY

Aspects of the disclosure relate to methods, systems, and/or non-transitory computer-readable mediums for predicting events and detecting missed events.

In some aspects, the techniques described herein relate to a method, including: receiving an event identifier and historical data for at least one event; calculating an event frequency of the at least one event; identifying a first model of a plurality of models, wherein the first model is identified based on the calculated event frequency of the at least one event, and wherein a different models are associated with different event frequency designations; training the first model based on the historical data for the at least one event, wherein training the first model based on the historical data for the at least one event further comprises: identifying at least one event change point in the historical data; and calculating an event time slot based on the at least one event change point in the historical data; and generating a prediction of one or more predicted future events based at least in part on the first model.

In some aspects, the techniques described herein relate to a method, further including: monitoring for the one or more predicted future events based on the calculated event frequency of the at least one event; and detecting when a given predicted future event of the one or more predicted future events does not occur.

In some aspects, the techniques described herein relate to a method, further including: initiating an alert when the given predicted future event of the one or more predicted future events does not occur.

In some aspects, the techniques described herein relate to a method, in which an event frequency comprises: one of daily, weekly, monthly quarterly, or yearly.

In some aspects, the techniques described herein relate to a method, further including calculating the event frequency comprises: calculating a mean frequency for the event.

In some aspects, the techniques described herein relate to a method, in which the first model of the plurality of models comprises one of: a seasonality model, a sequence model, a transformer model, a statistical model, or a rules-based model.

In some aspects, the techniques described herein relate to a method, in which generating a prediction of one or more predicted future events based at least in part on the first model comprises: estimating at least one event time within the calculated event time slot for the one or more predicted future events.

In some aspects, the techniques described herein relate to a method, in which the event frequency designations comprise one of: a frequent event, a moderate event, or a rare event.

Is some aspects systems and non-transitory computer-readable mediums are likewise described. Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an illustrative system for predicting events and detecting missed events, in accordance with at least one embodiment;

FIG. 2 depicts an example method for predicting events and detecting missed events, in accordance with at least one embodiment;

FIG. 3 depicts a training protocol for frequent events, according to at least one embodiment; and

FIG. 4 depicts an example computer system on which systems and methods described herein may be executed, in accordance with at least one embodiment.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments.

To mitigate the problems described herein, the inventors had to both invent solutions and, in some cases just as importantly, recognize problems overlooked (or not yet foreseen) by others in the field of automating event prediction and missed event detection. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Embodiments provide systems and methods that automatically learn event patterns based on historical usage. Using this information, embodiments may predict when a future event will occur, and provide an alert when the event does not occur at the expected time. Embodiments, at a high-level, may enable at least the following steps to address various problems with prior systems and methods: (1) identify the event frequency (hourly, daily, etc.); (2) identify the frequency slot during which the event is expected to occur (for example: a file may be expected to be uploaded on Tuesdays, Wednesdays, and Thursdays); and (3) within the frequency slot, predict the time when the event should occur and a range of this time (e.g., earliest and latest time of the event).

In some embodiments, the task of predicting events in the future may have two key elements: (1) detecting, predicting, or otherwise identifying repeatable event patterns for a process based on historical information (e.g., using statistical methods to classify different events); and (2) detecting missed events, e.g., events that were predicted to occur but ultimately do not occur in the process.

Accordingly, the systems and methods provided herein may provide tangible real-world benefits and improvements to legacy monitoring and missed event detection systems and methods, for example, by: automating the monitoring of important events; reducing false positives; providing early indicators of potential problems in business or technology processes; enabling integration of prediction models with other tools having events; and being adaptable to many types of use cases to drive increased resiliency and client satisfaction with reduced risk. These and other aspects of the systems and methods for predicting events and detecting missed events will be further described in detail herein.

The following terminology is used herein, according to various embodiments:

Event frequency: frequency of the occurrence of an event (e.g., “repeatable events”), e.g., 1 hour, 2 hours, daily, weekly, monthly, quarterly, and/or yearly, etc.

Event time: the occurrence time of a particular event, e.g., the time of an API call or a file arrival.

Time slot: a window in a range, e.g., an equally spaced range, identified by the event frequency.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions. These and other features are described in detail herein with reference to the foregoing figures.

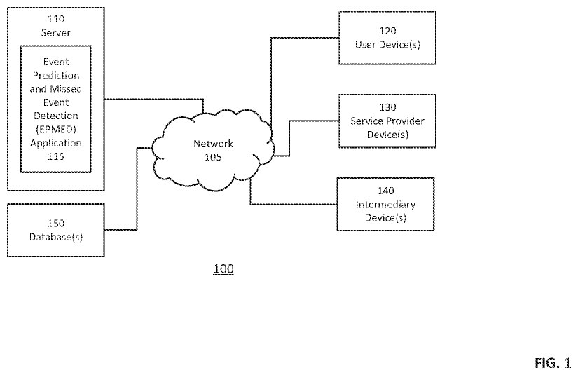

FIG. 1 depicts an illustrative system for predicting events and detecting missed events, in accordance with at least one embodiment. FIG. 1 illustrates a functional block diagram of an embodiment of an event prediction and missed event detection system 100 within which at least some of the disclosed techniques may be implemented. The event prediction and missed event detection system 100 may be established to predict expected events between various entities and/or within an entity, via network 105, and detect when those events do not occur, e.g., when they are missed.

In some embodiments, various devices and applications described herein may be configured to communicate via network 105. In some embodiments, computing devices and servers described herein may communicate over network 105, which, in various embodiments, may be any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 105 may be any combination of the above, which may be a combination of private and public networks.

In some embodiments, each of the elements of event prediction and missed event detection system 100 may be or may include applications executed on respective computing systems, though this need not always be the case. In some examples, one or more of the applications may be executed on a single computing system (which is not to suggest that such a computing system may not include multiple computing devices or nodes, or that each computing device or node need be co-located; indeed, a computing system including multiple servers that house multiple computing devices may be operated by a single entity and the multiple servers may be distributed, e.g., geographically). For example, in some embodiments, an individual or entity may execute an event prediction and missed event detection (EPMED) application 115 on a server or other computing system, e.g., server 110. Moreover, in some examples, an entity may also provide users access to an EPMED application 115 via various user devices (e.g., user device(s) 120, Service Provider Device(s) 130, Intermediary Device(s) 140, etc.), which may be a web-based application hosted by a computing system managed by or provisioned by the entity, or which communicates with such a computing system via an application programming interface (API). Accordingly, one or more of the devices/systems/elements depicted herein may communicate with one another via messages transmitted over network 105, such as the Internet and/or various other local area networks. For example, one or more applications may communicate via messages transmitted over network 105.

In some example embodiments, server 110 may include, host, or otherwise execute EPMED application 115. In some embodiments, EPMED application 115 may be a user facing application with which a user interfaces to access various aspects of the systems and methods described herein. For example, a user of user device 120 may access features of EPMED application 115 described herein, e.g., to initiate and execute systems and/or methods of prediction of events and/or detection of missed events, as described herein. Likewise, various service providers and/or intermediaries may access, interact with, and/or communicate via EPMED application 115 from devices 130 and 140, respectively, as described herein. While only one instance of an EPMED application 115 is shown, embodiments of event prediction and missed event detection system 100 may include any number of such applications accessed by different users on or from their respective computing systems. The EPMED application 115 and users of the system (e.g., administrators, managers, service providers, intermediaries, end users, etc.) may be isolated from accessing some or all of the features and/or information associated with the EPMED application 115, except as described herein.

In some embodiments, EPMED application 115 may include a user interface through which a user may interact with event prediction and missed event detection system 100 via various user devices, e.g., devices 120, 130, or 140. For example, an administrator or other user may desire to initiate prediction of events and/or detection of missed events relating to a service provider. According to embodiments, the user, using user device 120 may interact with a user interface of EPMED application 115, accessing only the data and/or features which the user is permitted to access, which in turn may send a request or instruction, via an application programming interface (API) associated with server 110, to facilitate prediction of events and/detection of one or more missed events relating to the service provider.

By way of another example, an administrator within an entity (e.g., a service provider) may be provided a screen in a graphical user interface (GUI) which may be utilized to set up event prediction and/or detection of missed predicted events handled by the entity over a given period of time, during different time frames, etc., as described herein. In some embodiments, EPMED application 115 may be accessed via a GUI to implement one or more of the systems and methods described herein.

Additionally, embodiments may utilize data (e.g., historical event data, data relating to various individuals or entities associated with particular events, event identifiers (IDs), etc. Such data may be stored, for example in one or more databases, e.g., database(s), which may be internal and/or external (e.g., third-party, intermediatory, etc.) databases. In some embodiments, event IDs (e.g., event names, numeric or alphanumeric tags, etc.) may be collected or otherwise provided from various internal and/or external sources. In some embodiments, event IDs may be normalized, e.g., to enable identification of the same event across multiple units of frequency. Of course, in various embodiments, event IDs may be stored in their received form and normalized when needed, normalized upon receipt and stored in their normalized form, etc. In some embodiments, historical event data may include the time of an event, e.g., in the form of timestamps. In some embodiments, recorded timestamps may employ various units to denote time intervals when events occur. These units may include, for example, milliseconds (ms), seconds(s), minutes (min), hours (h), days (d), weeks (w), months (m), years (y), etc., or any combination thereof. In various embodiments, different timestamp units may offer different scales of time granularity.

In some embodiments, historical event data may represent any repository or collection of data documenting past occurrences, actions, or transactions, e.g., within a system or process. A historical event dataset may encompass or include elements or information which may be used in understanding or determining the sequence and nature of events. In some embodiments, timestamps may provide precise records of event occurrences, enabling the establishment of chronological sequences and patterns. Descriptive event names or labels may offer context, describing the type of action or transaction undertaken. In some embodiments, event attributes or parameters may provide nuanced details and/or associated metadata regarding an event. Information on event status or outcomes—whether successful, failed, or encountered errors—may be included which may add further detail to the dataset. In some embodiments, historical event data may include or provide insights into the frequency, patterns, trends, and/or changes in event occurrences over time, enabling the identification of regularities or anomalies within sequences.

In some embodiments, historical event data can be gathered or received from diverse sources, spanning internal databases, proprietary systems, and external platforms. Internally, e.g., within an entity, historical event data may be sourced from databases storing, e.g., transactional records, logs generated by software applications, operational systems containing historical user interactions, etc. External sources may encompass data feeds from third-party APIs providing market or other data, social media platforms delivering user engagement metrics, IoT devices transmitting sensor data, etc. In some embodiments, online platforms like cloud services, web applications, or e-commerce sites may also yield historical event data, including user behavior, sales transactions, and/or system logs. In some embodiments, data warehouses consolidating information from various sources, historical backups, and archival systems may be accessed which may provide relevant historical event data.

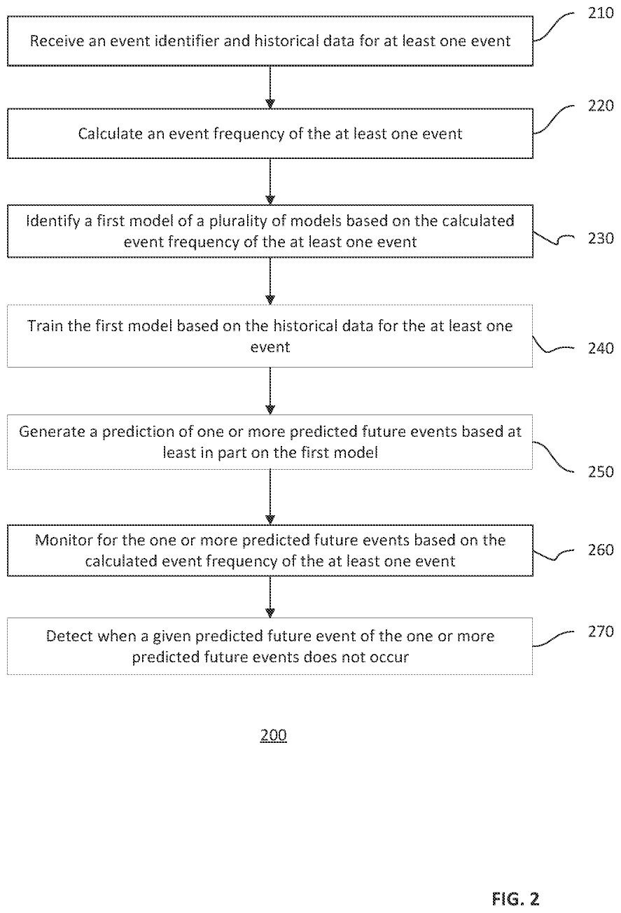

These and other features of event prediction and missed event detection system 100 will be further understood with reference to the evaluation request method 200 of FIG. 2, herein.

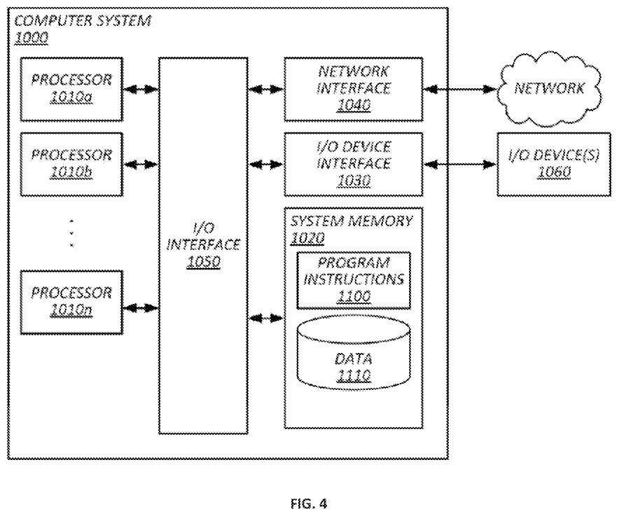

FIG. 2 depicts an example method for predicting events and detecting missed anticipated and/or predicted events, in accordance with at least one embodiment. In various embodiments, method 200 may be implemented by event prediction and missed event detection system 100, executing code in one or more processors therein. For example, in some embodiments, method 200 may be performed on a computer (e.g., computer system 1000 of FIG. 4) having one or more processors (e.g., processor(s) 1010 of FIG. 4) and memory (e.g., system memory 1020 of FIG. 4), and one or more code sets, applications, programs, modules, and/or other software stored in the memory and executing in or executed by one or more of the processor(s).

Method 200 begins at step 210 when a processor (e.g., of server 110) receives an event identifier (ID) and historical data for at least one event. As noted above, in various embodiments, an event ID may be an event name, event descriptor, or any combination of letters, numbers, and/or characters which uniquely identifies the event. In some embodiments, multiple event IDs, e.g., a list of unique event identifiers, may be received or retrieved by the processor. In addition to the event IDs, at least some threshold amount of historical event data may be required for each event ID.

At step 220, in some embodiments, the processor may calculate an event frequency of the at least one event. In some embodiments, the process for determining an event frequency for a particular event may involve a multi-step calculation methodology. Initially, for each event, a plurality of mean values, e.g., four mean values—weekly, monthly, quarterly, and yearly—may be computed. Depending on the derived mean values, the frequency may be categorized. For instance, if the weekly mean surpasses 1, this may signify a daily frequency, a monthly mean surpassing 1 may signify a weekly frequency, and a quarterly mean surpassing 1 may signify a monthly frequency; otherwise, the frequency may default to a yearly frequency (or another predefined default frequency).

In some embodiments, if the determined frequency is ‘daily,’ a subsequent sequence of steps may be undertaken. To determine a more specific frequency with a given day, event times may be arranged in ascending order and time intervals between consecutive values may be calculated, e.g., d(i)=x(i+1)−x(i), where d indicates the duration, i indicates the sequence position of the event, and x indicates the event time. In some embodiments, durations between all adjacent events may be calculated using this formula. In some embodiments, outliers, defined as intervals exceeding a given percentile, e.g., 75th percentile, may be removed. Subsequently, the average of the remaining intervals may be calculated and converted into a frequency measured, e.g., in hours. In some embodiments, results may be rounded up (or down) to the nearest integer. This calculated hourly frequency may then be mapped into specific categories, in which the default category is 1H and the categories reflect divisors of 24 hours.

For example, a calculated hourly frequency of less than or equal to 1 hour may be assigned to category 1H, less than or equal to two hours may be assigned to category 2H, less than or equal to three hours may be assigned to category 3H, less than or equal to four hours may be assigned to category 4H, less than or equal to six hours may be assigned to category 6H, less than or equal to twelve hours may be assigned to category 12H, and greater than twelve may be assigned to category 1D. Of course, more or fewer categories, with any category name or identifier, may also/alternatively be used. This process may allow for the precise classification of event frequencies, facilitating comprehensive analysis and categorization based on established time intervals and frequency ranges.

In some embodiments, in order to calculate the mean values for different timeframes (weekly, monthly, quarterly, yearly, etc.), the processor may implement different calculations. For example, to calculate a weekly mean, the processor may be configured to first generate and populate one or more of the following additional columns, e.g., in a database or spreadsheet: (a) day of the week, e.g., Monday; (b) week of the month, e.g., the week number within the month, with the value being between 1 and 5; (c) month of the year, e.g., the month of event time, with the value being between 1 and 12; and (d) year, e.g., the calendar year (e.g., 2023) or the year from the event time. Once the additional data is generated, in some embodiments, the processor may evaluate the newly added columns of data and drop or otherwise flag any duplicates, which may be ignored or removed. Then, in some embodiments, the processor may group the results, e.g., by week of the month, month of the year, and year (e.g., number of years since the event date), and tally a count for each group. The weekly mean may then be calculated from the average of the count column.

In some embodiments, the process of calculating a weekly mean may be implemented according to the following steps: 1. Arrange all the events in chronological order, each event having the following attributes: day of the week (e.g., Wednesday), week of the month (e.g., 3), month of the year (e.g., 12), and year (e.g., 2023). 2. If there is more than one event with the same set of attributes then duplicates may be removed. 3. The week of the month, month of the year, and year attributes may be scanned and a count of how many records there are for each unique combination may be calculated. 4. An average of those counts is calculated and labeled as weekly mean. 5. If the result is greater than 1 then the frequency is determined to be at least daily or more (e.g., hourly). 6. If the result is 1 or less then it is at least weekly or less frequent. In this case a monthly mean may be computed.

To calculate a monthly mean, in some embodiments, the processor may implement a similar process as with the weekly mean. For example, to calculate a monthly mean, the processor may be configured to first generate and populate one or more of the following additional columns, e.g., in a database or spreadsheet: (a) week of the month, e.g., the week number within the month, with the value being between 1 and 5; (b) month of the year, e.g., the month of event time, with the value being between 1 and 12; and (c) year, e.g., the year from the event time. Once the additional data is generated, in some embodiments, the processor may evaluate the newly added columns of data and drop or otherwise flag any duplicates, which may be ignored or removed. Then, in some embodiments, the processor may group the results, e.g., by month of the year, and year (e.g., the calendar year (e.g., 2023) or the number of years since the event date), and tally a count for each group. The monthly mean may then be calculated from the average of the count column.

In some embodiments, the process of calculating a monthly mean may be implemented according to the following steps: 1. Arrange all the events in chronological order, in which each event has the following attributes. week of the month (e.g., 3), month of the year (e.g., 12), and year (e.g., 2023). 2. If there is more than one event with the same set of attributes then duplicates may be removed. 3. The month of the year and year attributes may be scanned and a count of how many records there are for each unique combination may be calculated. 4. An average of those counts is calculated and labeled as the monthly mean. 5. If the result is greater than 1 then the frequency is determined to be weekly. 6. If it 1 or less then the frequency is at least monthly or less frequent. In this case a quarterly mean may be computed.

To calculate a quarterly mean, in some embodiments, the processor may implement a similar process as with the monthly mean. For example, to calculate a quarterly mean, the processor may be configured to first generate and populate one or more of the following additional columns, e.g., in a database or spreadsheet: (a) month of the year, e.g., the month of event time, with the value being between 1 and 12; (b) quarter of the year, e.g., the quarter number within the year, with the value being between 1 and 4; and (c) year, e.g., the calendar year (e.g., 2023) or the year from the event time. Once the additional data is generated, in some embodiments, the processor may evaluate the newly added columns of data and drop or otherwise flag any duplicates, which may be ignored or removed. Then, in some embodiments, the processor may group the results, e.g., by quarter of the year, and year (e.g., number of years since the event date), and tally a count for each group. The quarterly mean may then be calculated from the average of the count column.

Finally, to calculate a yearly mean, in some embodiments, the processor may implement a similar process as with the quarterly mean. For example, to calculate a yearly mean, the processor may be configured to first generate and populate one or more of the following additional columns, e.g., in a database or spreadsheet: (a) quarter of the year, e.g., the quarter number within the year, with the value being between 1 and 4; and (b) year, e.g., the year from the event time. Once the additional data is generated, in some embodiments, the processor may evaluate the newly added columns of data and drop or otherwise flag any duplicates, which may be ignored or removed. Then, in some embodiments, the processor may group the results, e.g., by year (e.g., number of years since the event date), and tally a count for the group. The yearly mean may then be calculated from the average of the count column.

It should be noted that while various calculations have been outlined above as being separately implemented calculations, in some embodiments data from a relevant dataset may be processed, e.g., all at one time, on a rolling basis, or as needed, etc.

Next, at step 230, the processor may identify different models for evaluating events with different calculated event frequencies. For example, a first model may be identified based on the calculated event frequency of a given event. In some embodiments, different models may be identified for events with different event frequencies, with different models being associated with different event frequency designations, e.g., frequent events, moderate events, and/or rare events. Of course, in various embodiments and depending on the situation, the definition of a frequent event, a moderate event, and/or a rare event (and/or their corresponding designations) may be defined differently. For example, in the context of this disclosure, frequent events are generally understood to be events which occur hourly and/or daily. In such instances, there is assumed to be a substantial number of data points (e.g., 60-4000 data points). In these and other embodiments, a seasonality model may be implanted by the processor in order to predict further occurrences of the events.

A seasonality model, as used herein, is a statistical technique used to identify and analyze recurring patterns, fluctuations, or trends within time series data that follow a specific seasonal cycle or periodicity. These models aim to capture and understand the regular and predictable variations that occur at fixed intervals over time, such as daily, weekly, monthly, quarterly or yearly patterns. For instance, some seasonality models may utilize algorithms like Autoregressive Integrated Moving Average (ARIMA) to predict future milestones or performance based on historical data while accounting for seasonal variations. In these specific examples, the models may attempt to capture the cyclic nature of an industry or user engagement across different seasons, aiding in forecasting and decision-making within specific domains. Of course, in some embodiments, other statistical models may be implemented as well or in the alternative, e.g., for very frequent events, provided they account for calendar data.

In some embodiments, moderate events may be defined as events with weekly frequencies. Such events may have a relatively moderate number of data points when compared to frequent events (e.g., 10-30 data points), yet are not so infrequent so as to be considered rare events (as defined herein). In these and other embodiments, rather than implementing a seasonality model, a sequence model may be implemented by the processor in order to predict further occurrences of the events.

Sequence models, such as Mini GPT, Nano GPT, and other transformer models like Generative Pre-trained Transformer (GPT) models, are adept at processing sequential data and may be effectively applied to analyze weekly event sequences. These models may utilize attention mechanisms to comprehend contextual relationships within ordered information. By training, for example, on a series of weekly events, embodiments may capture dependencies and patterns within the sequence, enabling predictions, generation, or understanding of future or unseen weekly events. For instance, when trained on a sequence of events occurring weekly, in some embodiments, these models may forecast upcoming events, identify recurring patterns, and/or suggest probable sequences of events based on the learned patterns from historical weekly data.

In some embodiments, rare events may be defined as events with monthly, quarterly, and/or yearly frequencies. Such events may occur so rarely (relatively-speaking) that they have an insufficient number of data points (e.g., less than 5 data points) to train a model, e.g., as compared to frequent and moderate events. In these and other embodiments, rather than implementing a machine learning model, in some embodiments, a rule-based model or system may be implemented by the processor in order to predict events occurring in the future, as described herein.

In some embodiments, for frequent events, a separate model may be trained by the processor for each event, as described herein. In some embodiments, for moderate events, the processor may incorporate all the available data to create and train a single model that covers all the moderate events, as described herein. In some embodiments, for rare events which do not have enough data to train a model, a rule-based model may be implemented, as described herein. In each case, a result may be a prediction, e.g., a list of predicted future events for each time slot in the future.

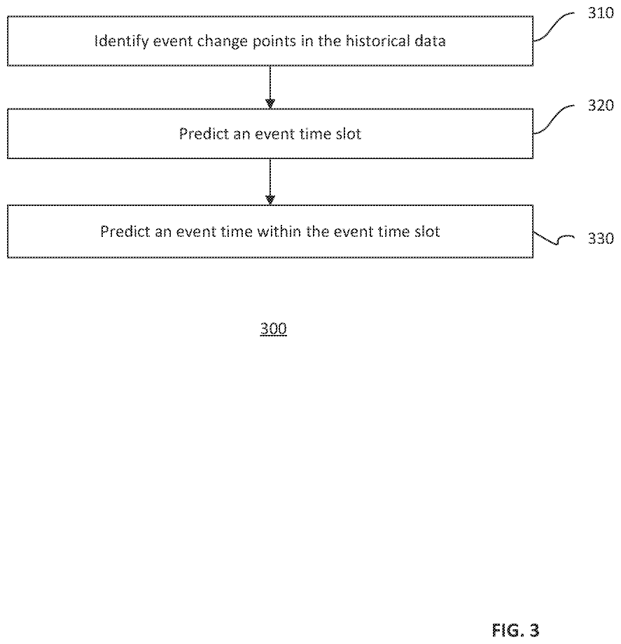

Next, at step 240, the processor may train a first model (e.g., an identified model for a given event) based on the historical data for the given event. In some embodiments, depending on the type of model identified, the processor may be configured to implement one of a plurality of different training protocols. For example, in some embodiments, a first example training protocol may be implemented for frequent events. As shown in FIG. 3., a training protocol 300 for frequent events is provided according to at least one embodiment. Training protocol 300 begins at step 310, when the processor is configured to identify at least one event change point in the historical data. As understood herein, an event change point is an identified point at which a scheduled event is changed.

In some embodiments, the process for identifying an event change point may involve several steps. Initially, recognizing that events' schedules evolve over time and incorporating extensive data before a change point may introduce inaccuracies in predictions, embodiments may instead focus on detecting the most recent change point and using only the historical data that succeeds the most recent change point. To achieve this, in some embodiments, the processor may compile a list of change points indicating transitions to new states within the time series. To detect these change points, in some embodiments, a change point framework may be employed by the processor.

In some embodiments, a change point framework may be implemented by a processor to analyze sequential data to identify abrupt shifts or alterations in the underlying structure or behavior of a dataset, e.g., the historical data relating to an event. The framework may operate by examining patterns, trends, or statistical properties within the data, aiming to pinpoint specific points or instances where a significant deviation, transition, or change occurs. These frameworks often employ statistical methods, algorithms, or machine learning techniques to detect these change points by assessing variations, such as changes in mean, variance, or other relevant characteristics, signaling a shift in the data distribution. By scrutinizing the sequential data for these abrupt alterations, change point frameworks may enable the processor to in delineating distinct segments or periods within the dataset, facilitating the identification of transition points that may denote changes in the data set. This approach may facilitate the identification of the latest change point, enabling the selection of relevant training data post-transition, minimizing noise in prediction models, and facilitating more accurate change point analyses for events. Once the change points are identified, in some embodiments, the processor may select the most recent one as the pivotal change point.

At step 320, in some embodiments, the processor may predict an event time slot, e.g., based on the historical data related to the event. The process may begin with the processor fetching the training data sorted by event time, e.g., in ascending order, starting from the identified change point, if applicable. If a time zone is specified, in some embodiments, the data may be converted to the relevant time zone, e.g., with UTC as the default. Subsequently, the start and end times of the training data may be determined, and the processor may generate a series of evenly spaced time intervals based on the frequency identified by the frequency classifier (as described herein). A label column may be added to or included with the dataset, initially set to zero, denoting the absence of events within each time slot. Upon comparison with the training data, if an event is found within a time slot, the label column for that slot may be updated to 1.

By way of example, Table 1 (below) shows an example training data set in which the frequency classification is 1H:

TABLE 1

| Event Time | Number of events |
|---|---|
| May 7, 2023 12:34:22 | 12 |
| May 7, 2023 14:00:12 | 100 |
| May 7, 2023 14:01:12 | 2 |

Table 2 (below) shows example data generated for the events of Table 1, based on the process described herein:

TABLE 2

| Time Slot Start Time | Time Slot End Time | Label |
|---|---|---|
| May 7, 2023 12:00:00 | May 7, 2023 12:59:59 | 1 |
| May 7, 2023 13:00:00 | May 7, 2023 13:59:59 | 0 |
| May 7, 2023 14:00:00 | May 7, 2023 14:59:59 | 1 |

In some embodiments, to generate predictions, the processor may utilize a time series model that supports seasonality, such as, for example, Prophet, with specified hyperparameters such as additive seasonality mode, bank holidays, regressors, change points, etc., In some embodiments, the data may be split into a training set and a testing set (e.g., 90% for training and 10% for testing). The processor may then fit the time series model using the training data, with the start time of each time slot as the time variable and the predicted value marked, e.g., as Y. For the prediction phase, in which predictions may be within a range, e.g., from 0 to 1, in some embodiments, a classification threshold may be established within the range, to determine event an occurrence. In such embodiments, predications above the classification threshold would be expected to occur, while predications below would not be expected to occur. In some embodiments, the classification threshold may be calculated by first generating predictions on the test data, and segregating the dataset into two sets, one that all the ‘0’ labels and one that all the ‘1’ labels. Then, in some embodiments, the processor may compute the mean using a combination of data from a defined percentile of the ‘0s’ (e.g., the 80th percentile) and a defined percentile of ‘1s’ (e.g., the 20th percentile). The processor may then employ the model to predict future events, with the predictions converted to binary outcomes (1s and 0s) based on the established threshold (e.g., predications below the threshold converted to 0 and predictions above the threshold converted to 1). Finally, in some embodiments, the resulting predictions of event time slots during which events are likely and/or unlikely to occur may be stored for further analysis and evaluation.

Finally, at step 330, the processor may predict an event time within the event time slot. In some embodiments, initially, the training data may be retrieved and sorted based on event time, e.g., in ascending order, starting from the identified change point, if applicable. To enhance the training data, in some embodiments, the processor may generate two additional columns of data, e.g., in the database or spreadsheet: one for the start time (ds) of each time slot and another for the offset in minutes from the time slot start time (y).

By way of example, Table 3 (below) shows an example of the above training data with the additional columns added:

TABLE 3

| Event time | Event frequency | ds | y |
|---|---|---|---|
| 2023 Jul. 7 12:34 | 1 H | 2023 Jul. 7 12:00 | 34 |
| 2023 Jul. 7 13:00 | 1 D | 2023 Jul. 7 00:00 | 780 |
| 2023 Jul. 7 07:00 | 2 H | 2023 Jul. 7 06:00 | 60 |

Subsequently, in some embodiments, the processor may calculate the mean for each time slot of the day, removing events that deviate beyond a defined threshold, e.g., +2 standard deviations. In some embodiments, the data may then be divided into a training set and a testing set (e.g., 90% portion for training and 10% portion for testing). The processor may then fit the time series model using the training data, with the start time of each time slot as the time variable and the predicted value marked, e.g., as Y. In some embodiments, in the process of generating future predictions, the processor may generate future time slots (ds) based on the event frequency, using the time slot start time to predict the ‘Y’ value utilizing the trained model.

By way of example, Table 4 (below) shows an example predication for frequency 2H:

TABLE 4

| ds | Y-hat (Y\hat{ }) | Lower | Upper |
|---|---|---|---|
| 2023 Jul. 7 12:00 | 30 | 15 | 45 |
| 2023 Jul. 7 14:00 | 32 | 16 | 45 |
| 2023 Jul. 7 16:00 | 50 | 25 | 55 |

Considering the wide range that the upper and lower bounds can encompass for consistent events, in some embodiments, adjustments may be made to refine these bounds. For example, in some embodiments, the processor may be configured to adjust the lower value, e.g., by some set increment, and validate the lower bound by selecting a lower percentile of similar time slot training data after removing any outliers. For example, in some embodiments, the processor may calculate a low percentile, e.g., the 1st percentile of similar time slot training data after removing events that deviate beyond a defined threshold, e.g., +2 standard deviations. If the adjusted lower bound is less than the 1st percentile, and the 1st percentile is less than the predicted value, then the processor may select the 1st percentile as the lower value. Otherwise, the processor may keep the lower value as it is.

Similarly, and by way of another example, in some embodiments, the processor may be configured to adjust the upper value, e.g., by some set increment, and validate the upper bound by selecting a higher percentile of similar time slot training data after removing any outliers. For example, in some embodiments, the processor may calculate a high percentile, e.g., the 99th percentile of similar time slot training data after removing events that deviate beyond a defined threshold, e.g., ±2 standard deviations. If the adjusted upper bound is greater than the 99th percentile, and the 99th percentile is greater than the predicted value, then the processor may select the 99th percentile as the upper value. Otherwise, the processor may keep the upper value as it is.

Following these adjustments, in some embodiments, the processor may convert the relative time offset in the predicted, lower, and upper columns into absolute date-time values for each event in the dataset.

By way of example, Table 5 (below) shows and example of the converted absolute values of the dataset:

TABLE 5

| ds | Predicted | Lower | Upper |
|---|---|---|---|
| 2023 Jul. 7 12:00 | 2023 Jul. 7 12:30 | 2023 Jul. 7 12:15 | 2023 Jul. 7 |
| | | | 12:45 |
| 2023 Jul. 7 14:00 | 2023 Jul. 7 12:32 | 2023 Jul. 7 12:16 | 2023 Jul. 7 |
| | | | 12:45 |
| 2023 Jul. 7 16:00 | 2023 Jul. 7 12:30 | 2023 Jul. 7 12:15 | 2023 Jul. 7 |
| | | | 12:45 |

It will be evident that at this stage, two model outputs have been generated: one predicting the presence or absence of an event within the time slot (e.g., a Boolean output), and the other predicting the occurrence time, the earliest occurrence time, and the latest occurrence time, for all time slots. In some embodiments, only predictions from the second model's predictions corresponding to ‘true’ values from the first model output may be retained. In some embodiments, the processor may combine or consolidate these two outputs into one dataset containing the time slot start and end times, event predicted time, earliest event time, and latest event time for each event. Note, in embodiments where a time zone conversion was conducted before training, in some embodiments, the times may be reverted back, e.g., to GMT, and stored in the database. Additionally, in some embodiments, the ground truth of the first model may be saved in the database, acting as a confidence score when sending alerts. In some embodiments, alerts may only be triggered for events possessing a high confidence score, e.g., 0.8 or above.

Returning to step 240, in some embodiments, a second example training protocol may be implemented for moderate events. As noted previously, in some embodiments, only one model is trained on all event data/types, rather than creating models for each event type. For example, a single model may be trained for all events classified as weekly.

In some embodiments, the processor may start the sequence model training procedure by loading all weekly events and organizing them by event name and event time. Employing a sequence model, the processor may predict a subsequent set of tokens based on the preceding set of tokens, as described herein. In some embodiments, tokens may be constructed using a defined pattern, e.g., a pattern that combines the month number and week of the month (m<month number>w<week of the month>). Of course, other patterns may be implemented in various embodiments.

In some embodiments, the processor may transform the time of each event into a text line, e.g., using the defined pattern to construct tokens, with words separated by spaces. The processor may utilize the data generated to train a sequence model, e.g., leveraging Mini GPT architecture or some other GPT model. By way of example, using a sentence such as “m01w01 m02w02 m03w03,” with a rolling window of 2, the processor may generate new lines “m01w01 m02w02” and “m02w02 m03w03.” As GPT models are typically programmed to understands words, in some embodiments, date time information may be converted into words or text. In order to do so, in some embodiments, the following format may be applied: m<month of the year>w<week of the month>. Subsequently, in some embodiments, the data may be split into a training set and a testing set (e.g., 90% for training and 10% for testing), and words may be encoded using a token dictionary. At this point, in some embodiments, the processor may construct a custom GPT model with specified hyperparameters such as, for example, max_epochs, learning_rate, lr_decay, warmup_tokens, and final_tokens, and train the model on the training data. Post-training, the processor may then apply the model to the test data to generate accuracy, fl_score, and precision metrics. Finally, the model may be employed to predict the next n words, convert these words into dates, and store them in the database for future reference and analysis.

In some embodiments, a third example training protocol may be implemented for rare events. As noted previously, rare events are events that are considered to be too infrequently occurring and therefore do not have enough data train a machine-learning model. This may include events with monthly, quarterly, and/or yearly frequencies. Accordingly, in some embodiments, the processor may implement a set of rules for known patterns. The set of rules may be augmented over time and/or in accordance with various embodiments.

In some embodiments, the processor may generate or otherwise define a set of variables to track the occurrence of events within a given frequency. For example, quarterly events may be represented by the following variables: (a) QS1, QS2, QS3, . . . QS10—based on the beginning of the quarter and the calendar day; (b) QSB1, QSB2, QSB3, . . . . QSB10—based on the beginning of the quarter and the business day; (c) QE1, QE2, QE3, . . . . QE10—based on the end of the quarter and calendar day; and (d) QEB1, QEB2, QEB3, . . . . QEB10—based on the end of the quarter and business day. In some embodiments, a calendar day may represent a sequential number of the day from the beginning of the quarter, e.g., for Jan. 13, 2023, the calendar day may be 13. In some embodiments, a business day may represent a sequential number of the day from the beginning of the quarter excluding weekends and holidays, e.g., for Jan. 13, 2023, the business day may be 10.

In some embodiments, these variables may be initialized to zero. For every occurrence of an event matching a given variable, the processor may increment the count of the variable. For example, if an event occurs on the 2nd business day of every month for 3 months, then QSB2 would have the value of 3. In some embodiments, the processor may then identify the variable with the maximum value and use that for prediction of the event in the future. For example, if QSB2 has the maximum value, then the processor may predict that the event will happen every month and will mark the 2nd business day as the earliest and latest expected event date.

Next, at step 250, the processor may generate a prediction of one or more predicted future events based at least in part on the first model. As described herein, in various embodiments, and depending on the event history, different predictions may be generated based on different models. Of course, in some embodiments, various combinations of models may be required. For example, a certain event may have periods during which its frequency may be increased (e.g., during a busy season, holiday season, etc.) and periods during which its frequency may be decreased (e.g., during summer months, etc.). Accordingly, classification of events as frequent, moderate, and/or rare may change, e.g., regularly or unexpectedly. In either case, the processor may determine that a different model is required, and may implement the required model to generate a prediction of one or more future events.

Next, at step 260, the processor may monitor for the one or more predicted future events based on the calculated event frequency of the at least one event. In some embodiments, the processor may initiate a monitoring process, continuously or periodically checking for events at specific intervals aligned with the forecasted frequency. Additionally, in some embodiments, the processor may continuously or regularly update these predictions by analyzing new incoming data and/or recalibrating the model, e.g., periodically. Once the predicted event frequency is established, the system may initiate a monitoring process while simultaneously updating the model as required.

Finally, at step 270, the processor may detect when a given predicted future event of the one or more predicted future events does not occur, e.g., a missed event. As time progresses, in some embodiments, the processor may compare the observed events and/or missed events with the predicted frequency, flagging any deviations or discrepancies. If the observed events differ from the expected frequency, the processor may trigger alerts or notifications to alert relevant stakeholders, indicating potential anomalies or changes in the anticipated event pattern. In some embodiments, at the end of each period, e.g., each hour, the processor may pull all the predicted events that have predicted time that matches the current time slot. If an expected event that matches the predicted event in the time slot was not detected, an alert may be generated.

Some embodiments may execute the above operations on a computer system, such as the computer system of FIG. 4, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, external (e.g., third party) content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B.

Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category.

Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

This monitoring process may allow the processor to proactively detect variations in event occurrence, aiding in timely decision-making or interventions based on the observed deviations from predicted event frequencies.

1. A method, comprising:
receiving an event identifier and historical data for at least one event;
calculating an event frequency of the at least one event;
identifying a first model of a plurality of models, wherein the first model is identified based on the calculated event frequency of the at least one event, and wherein a different models are associated with different event frequency designations;
training the first model based on the historical data for the at least one event, wherein training the first model based on the historical data for the at least one event further comprises:
identifying at least one event change point in the historical data; and
calculating an event time slot based on the at least one event change point in the historical data; and
generating a prediction of one or more predicted future events based at least in part on the first model.

2. The method of claim 1, further comprising:
monitoring for the one or more predicted future events based on the calculated event frequency of the at least one event; and
detecting when a given predicted future event of the one or more predicted future events does not occur.

3. The method of claim 2, further comprising: initiating an alert when the given predicted future event of the one or more predicted future events does not occur.

4. The method of claim 1, wherein an event frequency comprises: one of daily, weekly, monthly quarterly, or yearly.

5. The method of claim 4, wherein calculating the event frequency comprises:
calculating a mean frequency for the event.

6. The method of claim 1, wherein the first model of the plurality of models comprises one of: a seasonality model, a sequence model, a transformer model, a statistical model, or a rules-based model.

7. The method of claim 1, wherein generating a prediction of one or more predicted future events based at least in part on the first model comprises:
estimating at least one event time within the calculated event time slot for the one or more predicted future events.

8. The method of claim 1, wherein the event frequency designations comprise one of: a frequent event, a moderate event, or a rare event.

9. A system, comprising:
a computer having a processor and a memory; and
one or more code sets stored in the memory and executed by the processor, which, when executed, configure the processor to:
receive an event identifier and historical data for at least one event;
calculate an event frequency of the at least one event;
identify a first model of a plurality of models, wherein the first model is identified based on the calculated event frequency of the at least one event, and wherein different models are associated with different event frequency designations;
train the first model based on the historical data for the at least one event, wherein training the first model based on the historical data for the at least one event further comprises:
identifying at least one event change point in the historical data; and
calculating an event time slot based on the at least one event change point in the historical data; and
generate a prediction of one or more predicted future events based at least in part on the first model.

10. The system of claim 9, further configured to:
monitor for the one or more predicted future events based on the calculated event frequency of the at least one event; and
detect when a given predicted future event of the one or more predicted future events does not occur.

11. The system of claim 10, further configured to: initiate an alert when the given predicted future event of the one or more predicted future events does not occur.

12. The system of claim 9, wherein an event frequency comprises: one of daily, weekly, monthly quarterly, or yearly.

13. The system of claim 12, wherein calculating the event frequency comprises:
calculating a mean frequency for the event.

14. The system of claim 9, wherein the first model of the plurality of models comprises one of: a seasonality model, a sequence model, a transformer model, a statistical model, or a rules-based model.

15. The system of claim 9, wherein, when generating a prediction of one or more predicted future events based at least in part on the first model, the processor is further configured to:
estimate at least one event time within the calculated event time slot for the one or more predicted future events.

16. The system of claim 9, wherein the event frequency comprises: a frequent event, a moderate event, or a rare event.

17. A non-transitory computer-readable medium storing computer-program instructions that, when executed by one or more processors, cause the one or more processors to effectuate operations comprising:
receiving an event identifier and historical data for at least one event;
calculating an event frequency of the at least one event;
identifying a first model of a plurality of models, wherein the first model is identified based on the calculated event frequency of the at least one event, and wherein a different models are associated with different event frequency designations;
training the first model based on the historical data for the at least one event, wherein training the first model based on the historical data for the at least one event further comprises:
identifying at least one event change point in the historical data; and
calculating an event time slot based on the at least one event change point in the historical data; and
generating a prediction of one or more predicted future events based at least in part on the first model.

18. The non-transitory computer-readable medium of claim 17, further comprising:
monitoring for the one or more predicted future events based on the calculated event frequency of the at least one event; and
detecting when a given predicted future event of the one or more predicted future events does not occur.

19. The non-transitory computer-readable medium of claim 17, further comprising:
initiating an alert when the given predicted future event of the one or more predicted future events does not occur.

20. The non-transitory computer-readable medium of claim 17, wherein the event frequency designations comprise one of: a frequent event, a moderate event, or a rare event.
